(19) United States
(12) Patent Application Publication
(10) Pub. No.: US 2007/0050726 A1
(43) Pub. Date: Mar. 1, 2007

(54) INFORMATION PROCESSING APPARATUS AND PROCESSING METHOD OF DRAG OBJECT ON THE APPARATUS

(76) Inventors: Masanori Wakai, Kanagawa-ken (JP); Emiko Kamiyama, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/463,926

(22) Filed: Aug. 11, 2006

(30) Foreign Application Priority Data
Aug. 26, 2005 (JP) 2005-246428(PAT.)

(51) Int. Cl. G06F 9/00

(52) U.S. Cl. 715/769; 715/770; 715/835; 715/810

(57) ABSTRACT

During a drag of a first object in response to a drag operation of the first object selected on a screen, in a case that it is determined that the movement of the first object has stopped for a predetermined time period, the first object is dropped at the stopped location, and a second object displayed at the stopped location is designated as a new drag object.

### BACKGROUND OF THE INVENTION

1. Field of the Invention

The present invention relates to an information processing apparatus that allows for dragging icons, etc. displayed on a screen of the information processing apparatus by designating using a pointing device such as a mouse, and to a processing method of objects that are dragged on the apparatus.

2. Description of the Related Art

A drag & drop function is known in a PC (personal computer), which is a function of dragging an icon, etc. displayed on a screen and moving the icon in the drag state onto another icon of a folder or an application to drop it there. This function enables an action, such as copying, moving, deleting, sending, and playing data or launching an application corresponding to the icon, to take place with a simple operation. Because this function can make it easier to designate movement of files, etc., it helps improve the usability of an application and is in widespread use. There is a problem, however, that, in performing this operation, once an icon is selected and gets into a drag state, no other operation can be designated until the icon is dropped. Therefore, a variety of techniques to solve this problem have been proposed.

Japanese Registered Patent No. 02511638 describes that a behavior at a drop timing may be designated during a drag by passing through a processor object in the middle of the drag. Japanese Patent Application Laid-Open No. 2000-227828 describes that a behavior at a drop timing may be designated during a drag by performing a predetermined drag operation in close proximity of a drop location. Japanese Patent Application Laid-Open No. 2002-341990 describes that a window that may hinder a drop operation can be minimized by stopping the movement of an icon being dragged on a predetermined functional display during the drag. Japanese Patent Application Laid-Open No. 2001-069456 describes that the reproduction effect on an image can be designated by performing a predetermined drag operation on its thumbnail image.

In Japanese Registered Patent No. 02511638, however, if the processor object is away from a drag location or from an intended drop location, a drag to the processor object need to be performed. This impairs the usability of the drag & drop function. In addition, the processor object has effect on the behavior at a drop timing only, but cannot perform any operation on the drag object, such as replacing the object being dragged. Further, no consideration is given to achieving an operation which needs to repeat the drag & drop operation several times in a series of drags. Furthermore, the content of the operation given by the processor object to the icon cannot be determined until the icon is dropped.

In Japanese Patent Application Laid-Open No. 2000-227828, the drag operation that can be designated in close proximity of the drop location must be previously understood by the operator. Thus, there is a problem that the usability, which is the advantage of the drag & drop function, is impaired. In addition, the drag in close proximity of the drop location has effect on the behavior at a drop timing only, but does not enable any operation on the drag object, such as replacing the object being dragged, to be performed. It does not enable any operation which needs to repeat the drag & drop operation several times to be performed in a series of drags, either.

Japanese Patent Application Laid-Open No. 2002-341990 is directed to minimizing the window that may hinder the drop operation, which has no influence on the drag & drop function, itself. Thus, this does not enable any operation on the drag object, such as replacing the object being dragged, to be performed. This does not enable any operation which needs to repeat the drag & drop operation several times to be performed in a series of drags, either. Furthermore, Japanese Patent Application Laid-Open No. 2001-069456 is directed to specifying a reproduction effect on an image but has nothing to do with the drag & drop function itself, and thus does not enable any operation on the drag object, such as replacing the object being dragged, to be performed. This does not enable any operation which needs to repeat the drag & drop operation several times to be performed in a series of drags, either.

### SUMMARY OF THE INVENTION

It is an object of the present invention to overcome the above described shortcomings of the prior art.

A feature of the present invention provides a technique to enable additional operations to be designated during a drag before a drop operation takes place.

According to the present invention, there is provided with an information processing apparatus, comprising:

drag means for, in response to a drag of a first object on a screen, shifting to a drag state in which the first object is moved across the screen,

determination means for determining whether the movement of the first object has stopped for a predetermined time period during the drag, and

object execution means for executing processing of the first object, in a case that the determination means determines that the movement of the first object has stopped for the predetermined time period.

Further, according to the present invention, there is provided with a processing method of dragging a drag object on an information processing apparatus having at least a display unit and an input unit for specifying coordinates on a screen of the display unit, comprising:

a drag step of, in response to a drag of a first object selected on the screen, shifting to a drag state in which the first object is moved across the screen,

a determination step of determining whether the movement of the first object has stopped for a predetermined time period during the drag, and

an object execution step of executing processing of the first object, in a case that it is determined in the determination step that the movement of the first object has stopped for the predetermined time period.

Further features of the present invention will become apparent from the following description of exemplary embodiments with reference to the attached drawings.

### BRIEF DESCRIPTION OF THE DRAWINGS

FIG. 1 is a block diagram illustrating the hardware structure of an information processing apparatus according to an embodiment of the present invention;

FIG. 2 is a functional block diagram illustrating a functional structure according to the embodiment;

FIG. 3 depicts a view illustrating an example of drag in which objects are dragged in the first embodiment;

FIG. 4 depicts a view showing an example of drag object management data according to the first embodiment;

FIG. 5 is a flow chart illustrating drag processing according to the first embodiment;

FIG. 6 is a flow chart illustrating drag stop execution processing according to the first embodiment;

FIG. 7 depicts a view illustrating an example of drag of objects according to a second embodiment;

FIG. 8 is a flow chart illustrating drag stop processing according to the second embodiment;

FIG. 9 depicts a view illustrating an example of drag in which objects are dragged according to a third embodiment of the present invention;

FIG. 10 depicts a view showing an example of drag object management data according to the third embodiment;

FIG. 11 is a flow chart illustrating drag stop execution processing according to the third embodiment of the present invention;

FIG. 12 is a flow chart illustrating drag object determination processing according to the third embodiment;

FIG. 13 is a flow chart illustrating drag path object addition processing according to the third embodiment;

FIG. 14 depicts a view illustrating an example of drag in which objects are dragged according to a fourth embodiment of the present invention;

FIG. 15 depicts a view showing an example of drag object management data according to the fourth embodiment of the present invention;

FIG. 16 is flow chart illustrating drag stop execution processing (5507) according to the fourth embodiment;

FIG. 17 is a flow chart illustrating drag mode change processing according to the fourth embodiment;

FIGS. 18A and 18B depict views illustrating an example of drag in which objects are dragged in a fifth embodiment of the present invention;

FIG. 19 depicts a view showing an example of drag object management data according to the fifth embodiment of the present invention;

FIG. 20 is a flow chart illustrating drag processing according to the fifth embodiment; and

FIG. 21 is a flow chart illustrating drag stop execution undo processing (S2008) according to the fifth embodiment of the present invention.

### DESCRIPTION OF THE EMBODIMENTS

Preferred embodiments of the present invention will now be described in detail with reference to the accompanying drawings. It should be noted that the following embodiments are not intended to limit the present invention as set forth in the claims, and that not all the combinations of the features described in the embodiments are necessary for means for solving the problems of the present invention.

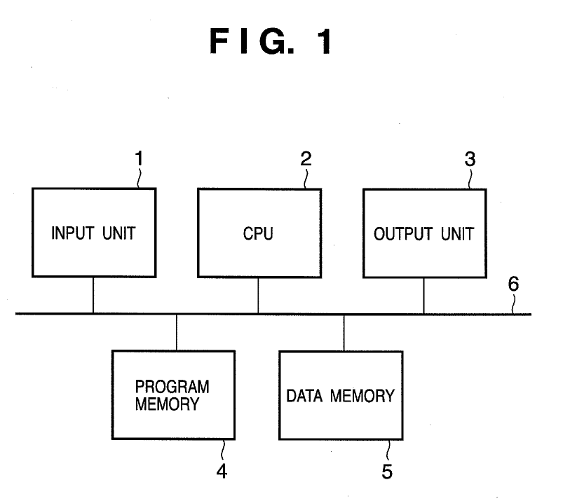

FIG. 1 is a block diagram illustrating the hardware structure of an information processing apparatus according to an embodiment of the present invention.

In FIG. 1, an input unit 1 is an input unit for inputting various types of information (data). The input unit 1 has a keyboard and a pointing device, such as a mouse, which are operated by a user for use in inputting commands, data, etc. A CPU 2 carries out operations, logical decisions, etc. for various types of processing according to a program stored in a program memory 4, and controls components connected to a bus 6. An output unit 3 is an output unit for outputting information (data). This output unit 3 includes a display such as an LCD and a CRT, or a recording device such as a printer. The program memory 4 stores a program containing the processing procedures of flow charts described later. The program memory 4 may be a ROM, or it may also be a RAM to which the program installed in an external storage (not shown) is loaded when the program is executed. A data memory 5 stores data generated in the various types of processing. The data memory 5 may be, for example, a RAM, and the data is then loaded to the data memory 5 prior to the processing, or is referred to as need arises, from a nonvolatile external storage medium. The bus 6 is a bus for transferring address signals that indicate elements to be controlled by the CPU 2, control signals that control the elements, data communicated with each other among the elements, etc. It should be noted that the information processing apparatus additionally has a network interface for communicating with the Internet, etc., a storage drive unit for reading/writing data from/to a storage medium such as a DVD or CD-ROM, an external storage such as a hard disk, etc., and others, although the description of these components is omitted here.

### First Embodiment

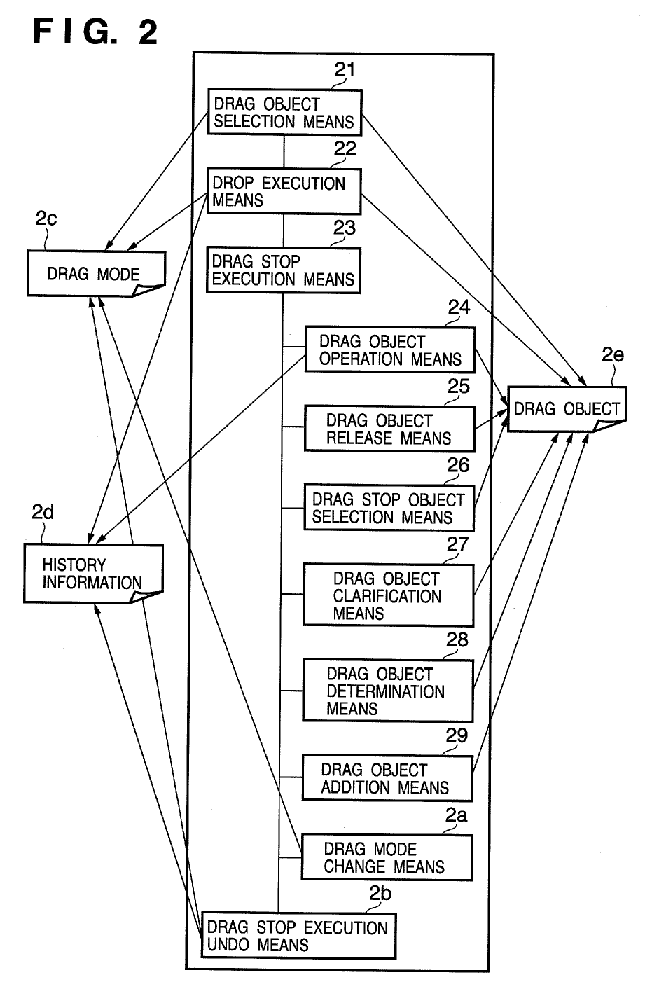

First, a first embodiment is described with reference to FIGS. 2 to 6. In the first embodiment, an example is described where processing equal to a drop operation and replacement of a drag object is executed by a stop operation during a drag. Also described is an example where an operation which needs to repeat the drag & drop operation several times can be achieved in a series of drags by this operation.

FIG. 2 is a block diagram illustrating a functional structure according to the embodiment. It should be noted that the means for executing these various types of functions are achieved by the CPU 2 executing the program stored in the program memory 4.

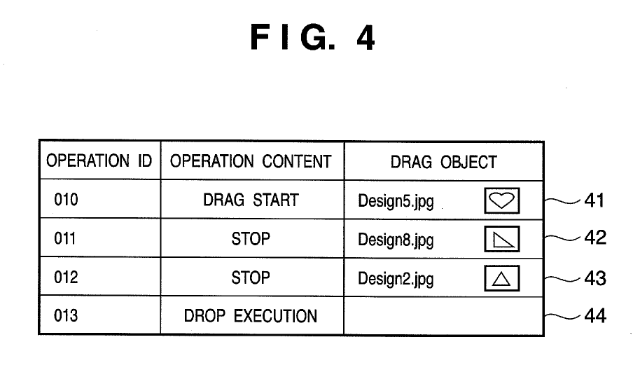

In FIG. 2, drag object selection means 21, when an icon on a screen is selected by a mouse cursor and shifts into a drag operation, selects an object at the drag location (dragged object, hereinafter referred to as a drag object 2e) and shifts into drag mode 2c. Drop execution means 22, in response to a drop operation of the dragged icon and corresponding to a folder or application icon, etc. at the drop location, executes on the drag object 2e any processing of copying, moving, deleting, sending, playing data, launching an application (hereinafter referred to as application launch), etc. corresponding to the dragged icon, and then releases the drag mode. Drag stop execution means 23 executes processing corresponding to a stop during a drag on the drag object. The stop during a drag represents a state where the movement of the icon being dragged has stopped for a predetermined time period (for example, one second) or more. Drag stop execution undo means 2b makes reference to history information 2d by the drop execution means 22 or the drag stop execution means 23, and executes the undo (redo) processing of the previously performed processing. The history information is stored as management data shown in FIGS. 4, 10, 15 and 19 as described later.

Drag object operation means 24 executes on the drag object 2e any processing of copy, move, delete, send, play, application launch, etc., corresponding to a stop location during a drag. Drag object release means 25 releases the selection of the drag object 2e. Drag stop object selection means 26 selects an object at a stop location during a drag. Drag object clarification means 27 displays the drag object 2e being dragged such that it is identifiable to the user by, for example, displaying as a transparent image. Drag object determination means 28 determines whether an object at a stop location during a drag corresponds with the drag object 2e. Drag object addition means 29 adds objects lying under a path on which the mouse cursor moves to reach a stop location during a drag as the drag object 2e. This enables several objects to be designated as a drag object in a single drag. Drag mode change means 2a changes drag mode. The control operations by these means will be described in detail below.

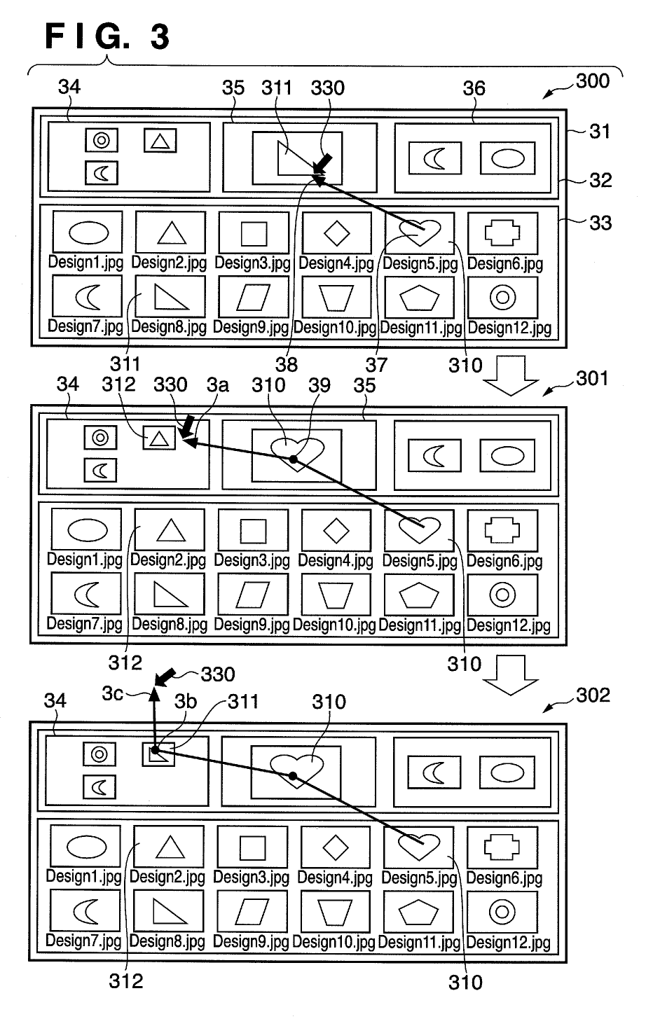

FIG. 3 depicts a view illustrating an example of drag in which objects are dragged in the first embodiment.

In FIG. 3, an object drag operation screen 31 has an other device display area 32 and an object display area 33 that displays a group of objects to be operated. In the other device display area 32, images 34, 35 and 36 corresponding to respective other devices are displayed, respectively.

Reference numeral 300 denotes a state where a drag as 38 is executed from a drag start location 37 in the object display area 33 (the location of an object 310) to an image 35 in the other device display area 32. The image 35 here previously displays an object 311. This is executed by the drag object selection means 21.

Reference numeral 301 denotes a state where the mouse cursor 330 is stopped at 39 on the image 35 and then is dragged as 3a to move onto an image 34 of another device by a drag continued from the state shown by reference numeral 300. Here, the object 311 of the image 35, which is the first drag stop location 39 after the drag start, is replaced with the object 310 of the drag start location 37. Now, the object 311 has become the new drag object. This is executed by the drag stop execution means 23, the drag object selection means 21, the drag object release means 25, and the drag stop object selection means 26.

Reference numeral 302 denotes a state where the mouse cursor 330 is stopped at a drag stop at 3b on the image 34 by a further continued drag, and then is dragged as 3c out of the drag operation screen display area 31. Here, an object 312 at the second drag stop location 3b is replaced with the object 311 at the first drag stop location 39. Also, the object 312 at the second drag stop location 3b is deleted. This is executed by the drag stop execution means 23, the drag object selection means 21, the drag object release means 25, the drag stop object selection means 26 and the drag mode change means 2a.

FIG. 4 depicts a view illustrating an example of drag object management data according to the first embodiment. This data is store in the data memory 5.

This drag object management data stores operation IDs that uniquely identify performed operations, the operation contents, and the operated drag objects 2e. For example, drag object management data 41 stores “010” for the operation ID, “Drag Start” for the operation content, and “Design5.jpg” (which corresponds to the object 310 in FIG. 3) for the drag object. Drag object management data 42 stores “011” for the operation ID, “Stop” for the operation content, and “Design8.jpg” (which corresponds to the object 311 in FIG. 3) for the drag object. Drag object management data 43 stores “012” for the operation ID, “Stop” for the operation content, and “Design2.jpg” (which corresponds to the object 312 in FIG. 3) for the drag object. Drag object management data 44 stores “013” for the operation ID, and “Drop Execution” for the operation content.

This corresponds to the drag & drop operation shown in FIG. 3 as described above.

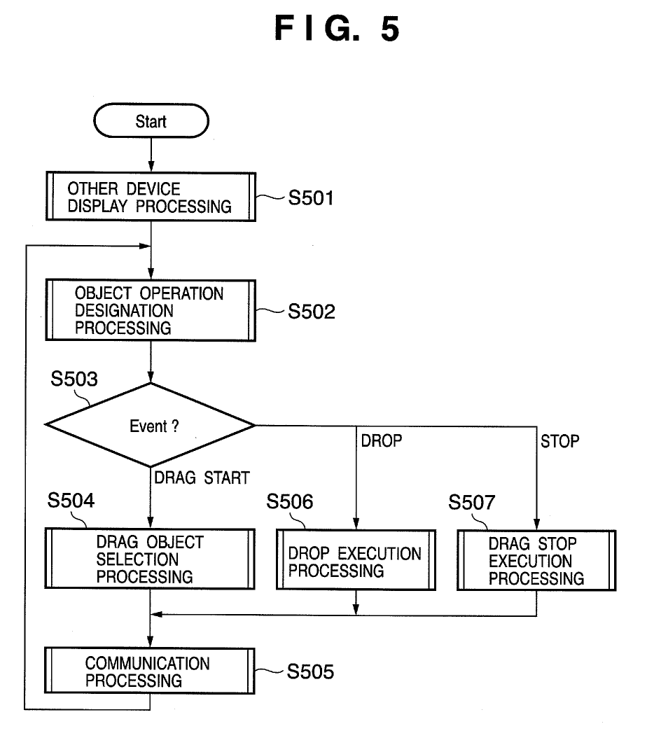

FIG. 5 is a flow chart illustrating the drag processing according to the first embodiment. The program executing this processing is stored in the program memory 4 and is executed under the control of the CPU 2.

First, in step S501, screen images of the other devices (e.g., 34-36 in FIG. 3) are generated with reference to data for simulation obtained from the other devices and are displayed using other device display processing. Next, in step S502, an object operating designation by a user who operates the input unit 1 is accepted. Next, in step S503, the process branches according to the type of the operation. In step S503, if it is determined that the operation is a drag start, the process proceeds to step S504 to select an object at the drag start location using drag object selection processing (which corresponds to the drag object selection means 21), and shifts into a drag mode. Next, in step S505, corresponding control data and object data is sent to the other device, and the process returns back to step S502 to repeat itself.

This can be described with the example 300 in FIG. 3 that, when it is determined that the operation is a drag start at the location 37, the process selects an object 310 at the drag start location 37 and shifts into the drag mode. This results in storing the data indicated by reference numeral 41 in FIG. 4.

Also, in step S503, if is it determined that the operation is a drop, the process proceeds to step S506, and executes on the drag object any processing of copy, move, delete, send, play, application launch etc. corresponding to the drop location by the drop. Next, the process releases the drag mode and proceeds to step S505.

Also, in step S503, if it is determined that the operation is a stop of the drag, the process proceeds to step S507, executes processing corresponding to the stop during the drag on the drag object using drag stop execution processing (which corresponds to the drag stop execution means 23), and then proceeds to step S505.

This can be described with the example 301 in FIG. 3 that, when it is determined that the operation is a drag stop at the location 39, the drag object 310 at that time is moved to the location 39; the object 311 located at the stop location 39 then is newly designated as a drag object. This results in storing the data indicated by reference numeral 42 in FIG. 4. This can also be described with the example 302 in FIG. 3 that, if it is determined the operation is a drag stop operation at the location 3b, the drag object 311 at that time is moved to the location 3b; then the object 312 is newly designated as the drag object. This results in storing the data indicated by reference numeral 43 in FIG. 4.

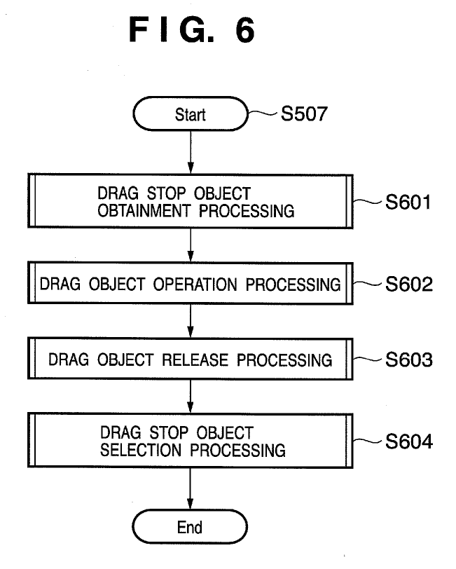

FIG. 6 is a flow chart illustrating the drag stop execution processing (drag stop execution means 23: S507) according to the first embodiment.

First, an object at the drag stop location is obtained using drag stop object obtainment processing (drag stop object selection means 26) in step S601. Next, the process executes on the drag object at that time any processing of copy, move, delete, send, play, application launch, etc. corresponding to the drag stop location using drag object operation processing (drag object operation means 24) in step S602. Next, the drag object is released in drag object release processing (drag object release means 25) in step S603. Next, the object obtained in step S601 is newly selected in drag stop object selection processing (drag stop object selection means 26) in step S604, and the process ends.

In this way, the first embodiment has the following advantages.

(a) By stopping the movement of the mouse cursor on the screen during a drag, a various types of processing can be executed on the drag object. This is advantageous in that the drag & drop function can be expanded without impairing the usability of the drag & drop function.

(b) By a stop operation during a drag, the drag object can be replaced.

(c) By a stop operation during a drag, processing equal to a drop can be executed. This enables even an operation which needs to repeat the drag & drop operation several times to be achieved simply by repeating the stop operation in a successive drag action.

### Second Embodiment

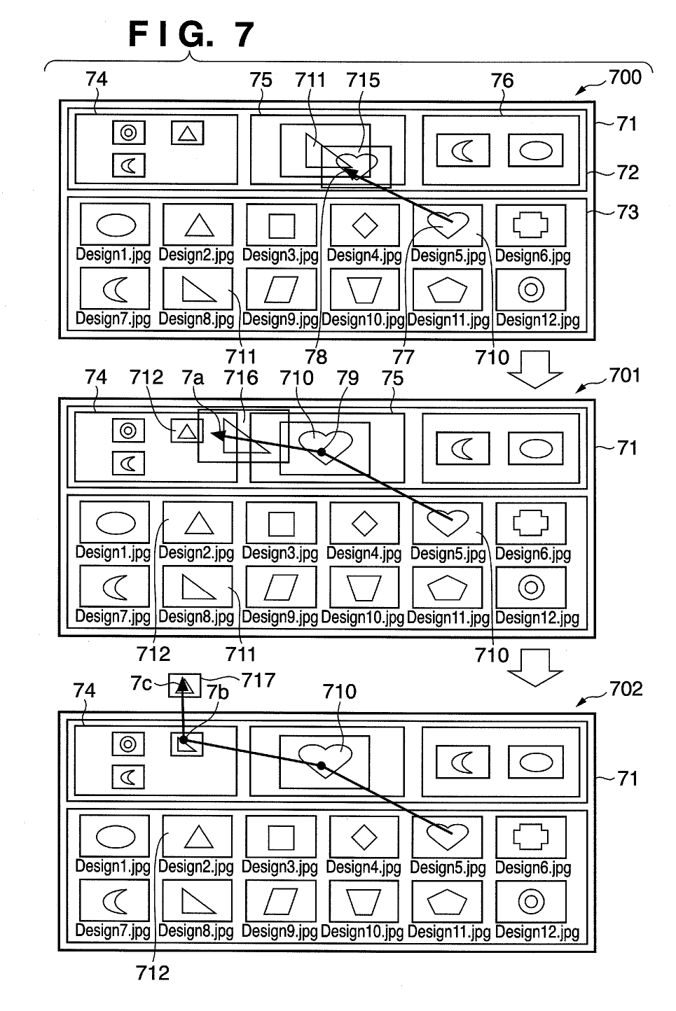

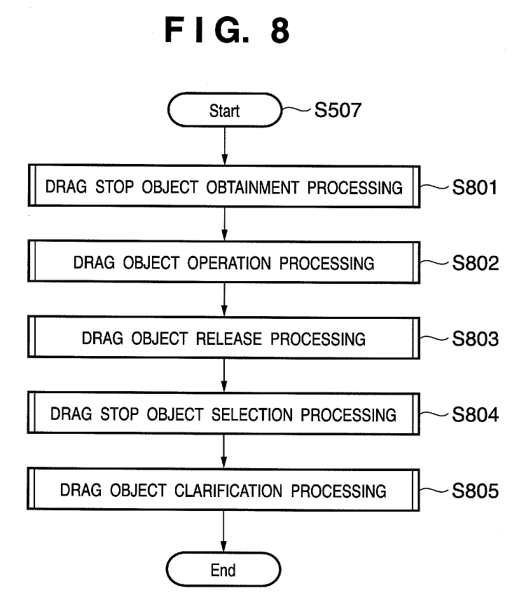

Next, a second embodiment of the present invention will be described. In the second embodiment, an example is described where an operation can be performed while viewing the processing state of the operation by identifiably displaying the effect of a drag stop operation with reference to FIGS. 7 and 8.

FIG. 7 depicts a view illustrating an example of the drag operation of objects according to the second embodiment of the present invention.

An object drag operation screen 71 contains an other device display area 72 and an object display area 73 which displays a group of objects to be operated. Within the other device display area 72, images 74, 75, and 76 corresponding to respective other devices are displayed.

In reference numeral 700, an object 710 in the object display area corresponding to a drag start location 77 is dragged as 78 onto the image 75 corresponding to another apparatus. The drag object 710 now being dragged is displayed as a transparent image 715. The display of the transparent image 715 is executed by drag object clarification means 27.

In reference numeral 701, an object 711 is dragged as 7a via a drag stop at 79 on the image 75 to the image 74 corresponding to another apparatus by a continued drag. Now, the drag object 711 of the image 75, which is newly dragged at the drag stop at 79, is displayed as a transparent image 716. Here, the object 711 at the first drag stop location 79 after the drag start is replaced with the object 710 at the drag start location 77. Next, the object 711 at the drag stop location 79 newly becomes the drag object.

Reference numeral 702 denotes a case where the drag object is dragged as 7c via a drag stop at 7b on the image 74 to the outside of the drag operation screen display area 71 by a further continued drag. Now, the drag object 712 being dragged, which is newly dragged at the second drag stop at 7b, is clearly displayed as a transparent image 717. Illustrated here is an example where the object 712 at the second drag stop location 7b is replaced with the object 711 at the first drag stop location 79, and the object 712 at the second drag stop location 7b is deleted. This is executed by the drag stop execution means 23, the drag object selection means 21, the drag object release means 25, the drag stop object selection means 26, the drag object clarification means 27, and the drag mode change means 2a.

FIG. 8 is a flow chart illustrating the drag stop processing (step S507 in FIG. 5: stop execution means 23) according to the second embodiment of the present invention. The processing in steps S801 to S804 in FIG. 8 are the same as in steps S601 to S604 in FIG. 6.

First, in drag stop object obtainment processing in step S801, an object at the drag stop location is obtained. Next, in drag object operation processing in step S802, any processing of copy, move, delete, send, play, application launch, etc. corresponding to the drag stop location is executed on the drag object that is selected at this point. Next, in drag object release processing in step S803, the drag object on which the operation is performed in step S802 is released. Next in drag stop object selection processing in step S804, the object obtained in step S801 is newly selected as the drag object. Next, in drag object clarification processing in step S805, the drag object being dragged is displayed as a transparent image and the process ends. The processing in step S805 corresponds to the display processing of the transparent images 715 to 717 of the drag objects in FIG. 7.

In this way, according to the second embodiment, the effect of a stop operation on a drag object can be viewed, and that the replacement of the drag object can also be identified.

### Third Embodiment

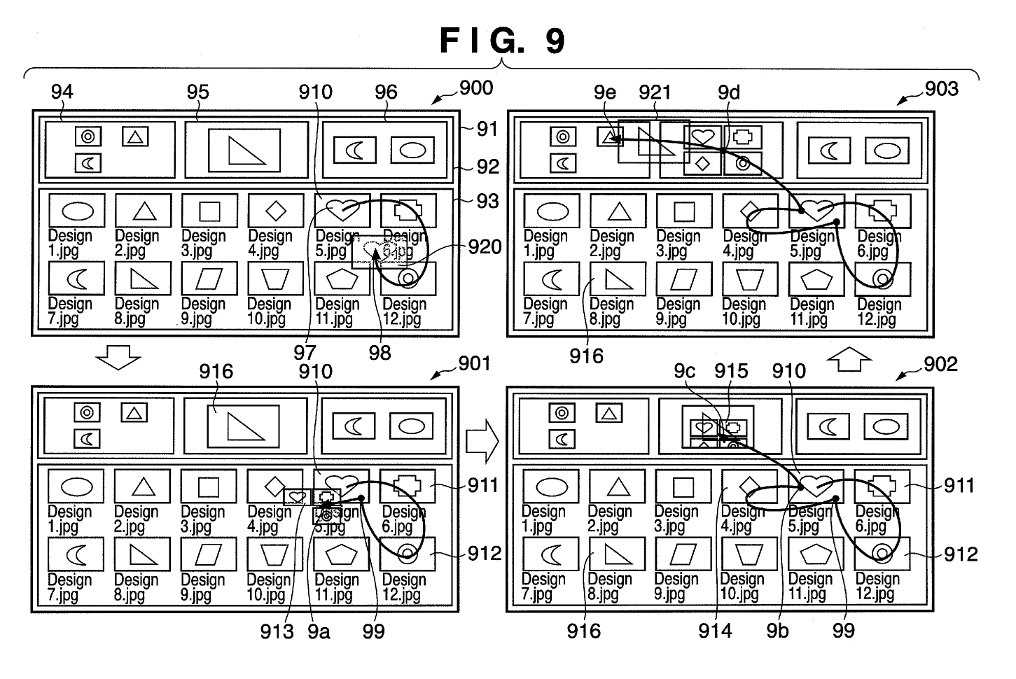

Next, a third embodiment of the present invention will be described. In the third embodiment, an example is described where drag objects can be added simply by a drag operation with reference to FIGS. 9 to 13.

FIG. 9 depicts a view illustrating an example of a state in which objects are dragged according to the third embodiment of the present invention.

An object drag operation screen 91 has an other device display area 92 and an object display area 93 that displays a group of objects to be operated. In the other device display area 92, images 94, 95, and 96 corresponding to respective other devices are displayed.

In reference numeral 900, an object 910 in the object display area corresponding to a drag start location 97 is dragged as 98 along a path passing through other objects. The drag object 910 being dragged in this state is displayed as a transparent image 920.

In reference numeral 901, a drag stop at 99 is made on the drag object being dragged by a continued drag, followed by a drag as 9a proceeds. Now, the objects 910 to 912 under the path on which the mouse cursor have moved from the drag start location 97 to the current drag stop location 99 are newly added to the drag object. The drag object obtained in this way is displayed as a transparent image 913.

Reference numeral 902 denotes an example where the mouse cursor is stopped at 9b on the drag object by a further continued drag, followed by a drag as 9c. Now, an object 914 under the path on which the mouse cursor has moved from the previous drag stop location 99 to the current drag stop location 9b is added to the drag object. In this way, the drag object consisting of the objects 910 to 912, 914 is displayed as a transparent image 915.

Further, in reference numeral 903, a drag stop at 9d is executed by a continued drag on the image 95, and followed by a drag as 9e. The drag objects 910 to 912, 914 being dragged are pasted on the image 95 at the current stop location 9d. Further, an image 916 located on this image 95 becomes a new drag object, the movement of which is displayed as a transparent image 921.

In this way, in FIG. 9, if the mouse cursor is moved after the start of the drag and returned back to the start location to make a drag stop there, the drag object on which the cursor has traced is replaced with a group of drag objects which additionally contains the objects. This enables a plurality of objects to be selected in a series of drags. This is achieved by adding drag object addition means 29 to the components as described above in FIG. 2.

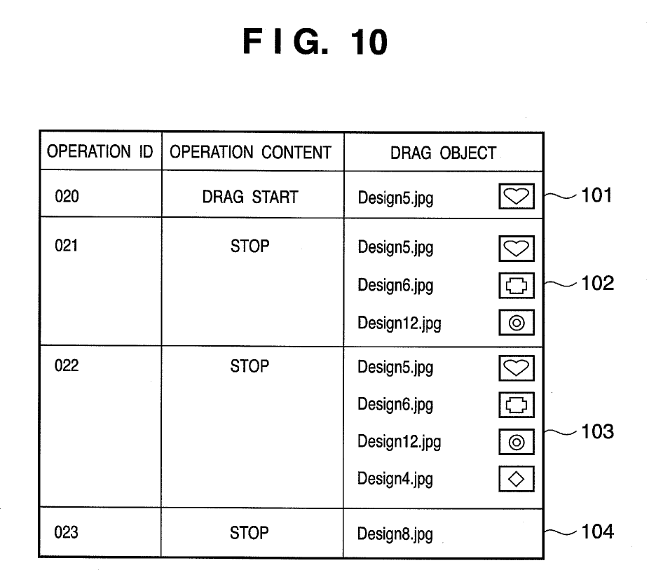

FIG. 10 depicts a view illustrating an example of drag object management data according to the third embodiment, which data is stored in the data memory 5.

The drag object management data is composed of operation IDs that uniquely identify performed operations, the operation contents, and a group of the operated drag objects. For example, drag object management data 101 stores “020” for the operation ID, “Drag Start” for the operation content and “Design5.jpg” corresponding to the object 910 in FIG. 9 for the drag object. This corresponds to the state of the drag start operation in reference numeral 900 in FIG. 9.

Drag object management data 102 stores “021” for the operation ID, “Stop” for the operation content and “Design5.jpg, Design6.jpg, Design12.jpg” corresponding to the objects 910 to 912 in FIG. 9 for the drag object.

This corresponds to the case in reference numeral 901 in FIG. 9 where the drag object becomes a drag object which additionally contains the objects 910 to 912 under the cursor path from the drag start location 97 to the drag stop location 99.

Further, drag object management data 103 stores “022” for the operation ID, “Stop” for the operation content and “Design5.jpg, Design6.jpg, Design12.jpg, Design14.jpg” corresponding to the objects 910 to 912, 914 in FIG. 9 for the drag object.

This corresponds to the case in reference numeral 902 in FIG. 9 where the objects 910 to 912, 914 under the path from the drag start location 97 to the drag stop location 9b have newly become the drag object.

Further, drag object management data 104 stores “023” for the operation ID, “Stop” for the operation content and “Design8.jpg” corresponding to the object 916 in FIG. 9 for the drag object.

This corresponds to the case in reference numeral 903 in FIG. 9 where the objects 910 to 912, 914 are dropped on the image 95 at the stop location 9d (that is, these objects are released) and the object 916 “Design8.jpg” of the image 95 becomes a new drag object 2e.

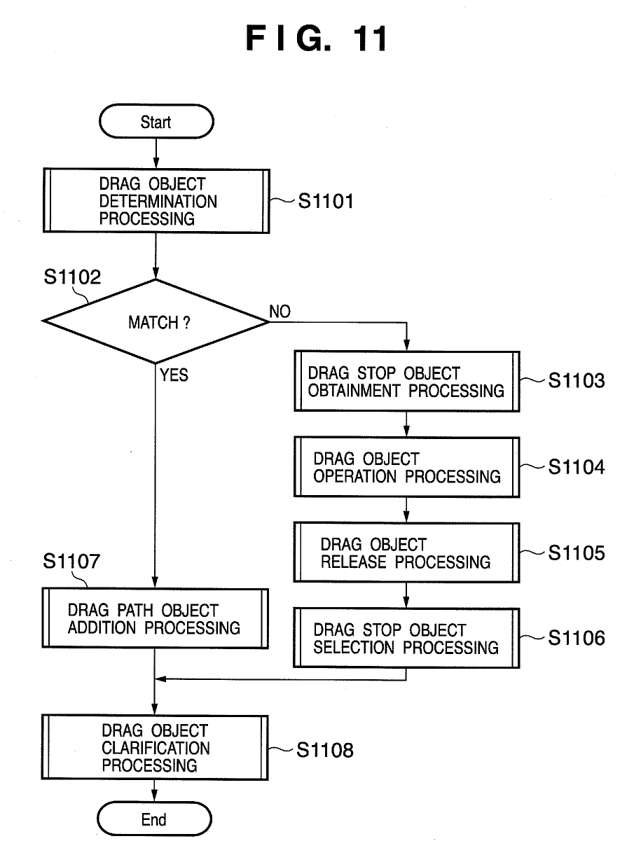

FIG. 11 is a flow chart illustrating the drag stop execution processing (step S507 in FIG. 5) according to the third embodiment of the present invention.

First, in drag object determination processing (which corresponds to the drag object determination means 28) in step S1101, a determination is made as to whether an object at a drag stop location matches the drag object being dragged. As a result, if it is determined that the object matches the object being dragged in step S1102, the process proceeds to step S1107, where all the objects on the mouse cursor path from the drag start location or the previous drag stop location are extracted and added to the drag object using drag object addition processing (which corresponds to the drag object addition means 29). Next, in drag object clarification processing (which corresponds to the drag object clarification means 27) in step S1108, the drag object being dragged is displayed as a transparent image and the process ends.

On the other hand, if it is determined that the object does not matches the object being dragged in step S1102, the process proceeds to step S1103, where the object at the drag stop location is obtained in drag stop object obtainment processing (which corresponds to the drag stop object selection means 26). Next, in drag object operation processing (which corresponds to the drag object operation means 24) in step S1104, any processing of copy, move, delete, send, play, application launch, etc. corresponding to the drag stop location is executed on the drag object. Next, in drag object release processing (which corresponds to the drag object release means 25) in step S1105, the object being dragged is released. Next, in drag stop object selection processing (corresponds to the drag stop object selection means 26) in step S1106, the object obtained in step S1103 is newly selected as a drag object and the process proceeds to step S1108.

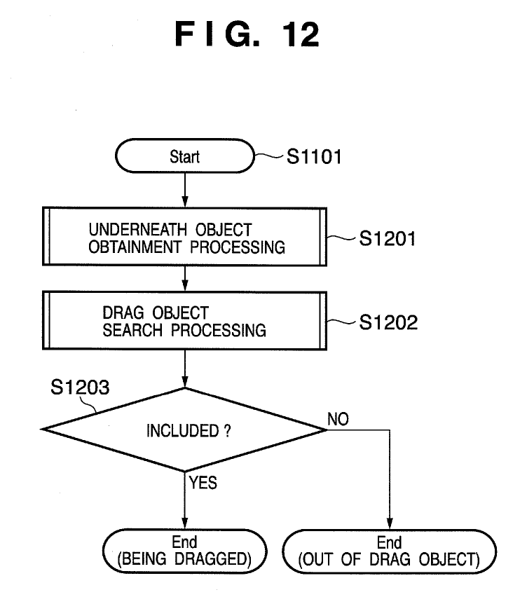

FIG. 12 is a flow chart illustrating the drag object determination processing (which corresponds to S1101: drag object determination means 28) according to the third embodiment.

First, in underneath object acquisition processing in step S1201, an object at the stop location is obtained. Next, in drag object search processing in step S1202, the drag object management data shown in FIG. 10 is searched to see if the object at the stop location is included in the drag object being dragged. As a result, if it is determined that it is in the drag object in step S1203, the process ends with a conclusion that it is being dragged, and if not, the process ends with a conclusion that it is not being dragged.

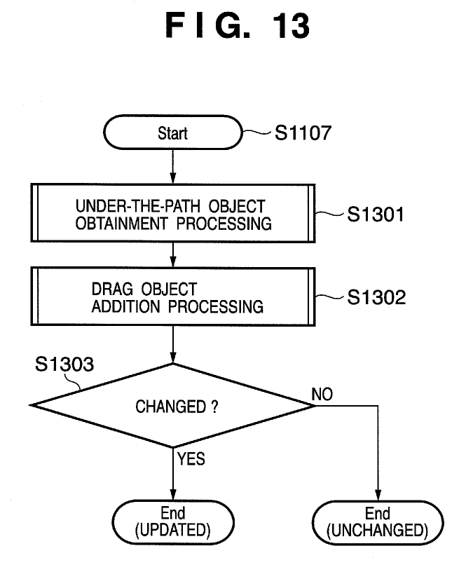

FIG. 13 is a flow chart illustrating the drag path object addition processing (which corresponds to S1107: drag object addition means 29) according to the third embodiment.

First, in under-the-path object obtainment processing in step S1301, a group of objects on the path from the drag start location or the previous drag stop location is obtained. Next, in drag object addition processing in step S1302, the group of the objects on the mouse cursor path is added to the drag object. As a result, in step S1303, a determination is made as to whether the group of the drag objects have been changed by adding the group of the objects, and if it is determined that there is a change, the process ends with a conclusion that the drag object has been updated, and if not, the process ends with a conclusion that the drag object remains unchanged.

In this way, the third embodiment enables the objects under the path of the mouse cursor from the immediately preceding stop location to be added to the drag object and be designated as a new drag object.

### Fourth Embodiment

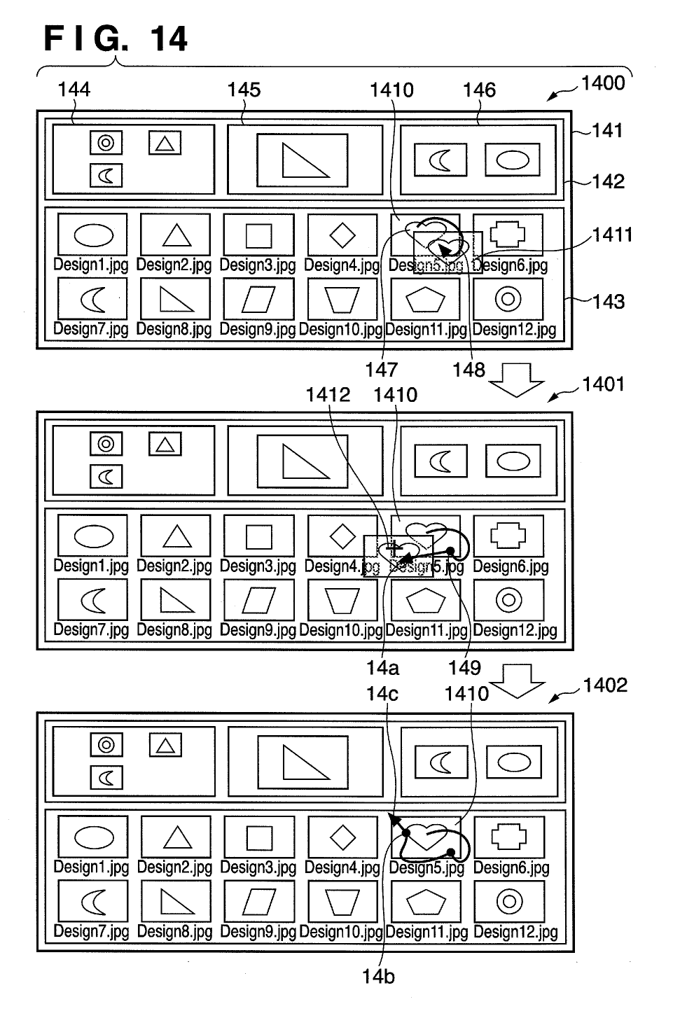

Next, a fourth embodiment of the present invention will be described with reference to FIGS. 14 to 17. The fourth embodiment is described in an example where a drag mode can be changed simply by a drag operation.

FIG. 14 depicts a view illustrating an example of a state in which objects are dragged according to the fourth embodiment of the present invention.

The object drag operation screen 141 has another device display area 142 and an object display area 143 that displays a group of objects to be operated. In the other device display area 142, images 144, 145 and 146 corresponding to respective other devices are displayed. In reference numeral 1400, an object 1410 in the object display area 143 corresponding to a drag start location 147 is dragged as 148 and the drag object being dragged is displayed as a transparent image 1411.

Next, in reference numeral 1401, a drag stop at 149 that stops the mouse cursor on the drag object being dragged 1410 is executed by a continued drag. Next, it is followed by a drag as 14a. Now, the drag mode is changed from “Move Mode” to “Copy Model” by this stop at 149. This mode change here is clearly displayed by the transparent image 1411 of the drag object with a mark toll 1412 added.

Further, in reference numeral 1402, a second drag stop at 14b is made on the drag object continuously being dragged, and followed by a drag as 14c. This now changes the drag mode from “Copy Mode” to “Normal Mode.” This change to the “Normal Mode” is indicated by displaying no transparent image of the drag object.

It is intended in the fourth embodiment that the drag object is designated to be copied in the “Copy Mode,” the drag object is designated to be moved in the “Move Mode” and no operation is performed on the drag object in the “Normal Mode.”

While the mode change is intended to be “Drag Move→Drag Copy→Normal” by repeating the drag stop operation in the fourth embodiment, a toggle operation of “Drag move←→Drag copy” may also be contemplated. Additional operation mode changes may also be accommodated.

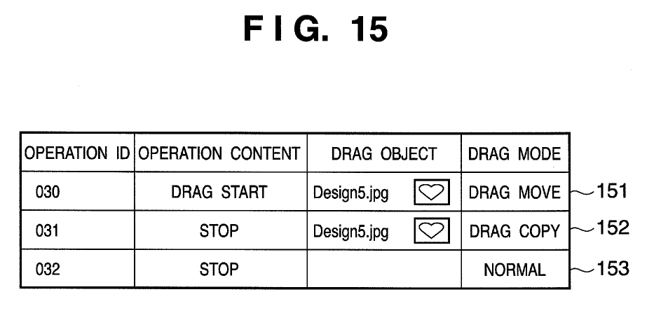

FIG. 15 depicts a view showing an example of drag object management data according to the fourth embodiment of the present invention.

The drag object management data stores operation IDs for uniquely identifying performed operations in association with the operation contents, the operated drag objects and the drag modes. For example, drag object management data 151 stores “030” for the operation ID, “Drag Start” for the operation content, “Design5.jpg” corresponding to the object 1410 for the drag object, and “Drag Move Mode” for the drag mode.

More specifically, this stores the state where a drag has started at the drag start location 147, the object 1410 in the object display area corresponding to the start location 147 has become the drag object “Design5.jpg” and is being moved by the drag as indicated by reference numeral 148 in FIG. 14.

Drag object management data 152 stores “031” for the operation ID, “Stop” for the operation content, “Design5.jpg” corresponding to the object 1410 for the drag object, and “Drag Copy” for the drag mode.

This shows that the drag stop at 149 has been made on the drag object 1410 being dragged and the drag mode has been changed from the “Drag Move Mode” to the “Drag Copy Mode” by the continued drag operation as indicated by reference numeral 1401 in FIG. 14.

Data in reference numeral 153 in FIG. 15 shows that the drag has been changed from the “Copy Mode” to the “Normal Mode” by the drag stop at 14b on the drag object continuously being dragged as indicated by reference numeral 1402 in FIG. 14. Because no operation is performed on the drag object here, the selection of the drag object is released.

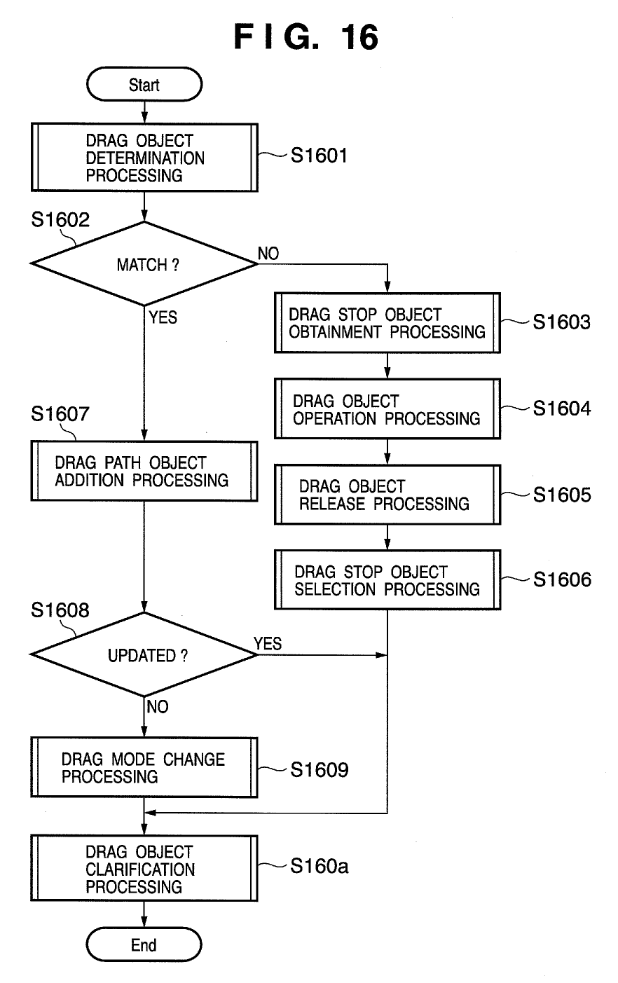

FIG. 16 is a flow chart illustrating the drag stop execution processing (S507) according to the fourth embodiment. The steps S1601 to S1607 in FIG. 16 are the same as the steps S1101 to S1107 FIG. 11.

First, in drag object determination processing in step S1601, a determination is made as to whether the object in the drag stop location matches the drag object being dragged. As a result, if it is determined that there is a match in step S1602, the process proceeds to step S1607, the objects on the path from the drag start location or the previous drag stop location are added to the drag object using drag path object addition processing. Next, in step S1608, a determination is made as to whether the drag object has been updated. As a result, if it is determined that it has not been updated, the process proceeds to step S1609 to change the drag mode using drag mode change processing. Next, in drag object clarification processing in step S16Oa, the drag object being dragged is displayed as a transparent image and the process ends.

On the other hand, if it is determined that there is no match in step S1602, the process proceeds to step S1603 to obtain the object at the drag stop location using a drag stop object acquisition processing. Next, in drag object operation processing in step S1604, any processing of copy, move, delete, send, play, application launch, etc. corresponding to the drag stop location is executed on the drag object. Next in drag object release processing in step S1605, the object being dragged is released. Next, in drag stop object selection processing in step S1606, the object obtained in step S1603 is newly selected as a drag object and the process proceeds to step S160a.

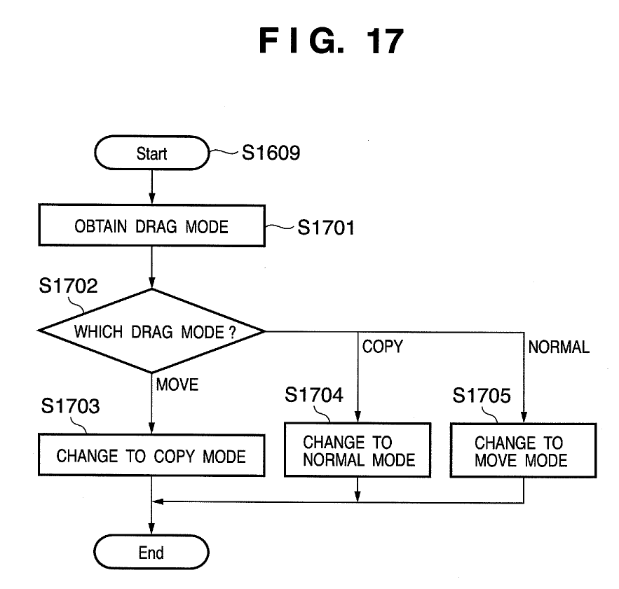

FIG. 17 is a flow chart illustrating the drag mode change processing (which corresponds to S1609: drag mode change means 2a) according to the fourth embodiment.

First, in step S1701, the drag mode at the stop time is obtained. Next, in step S1702, the drag mode is determined. As a result, if it is determined to be “Move Mode,” the process proceeds to step S1703 to set the drag mode to “Copy Mode,” and ends.

If it is determined to be “Copy Mode” in step S1702, the process proceeds to step S1704 to change it to “Normal Mode,” and ends. If it is determined to be “Normal Mode” in step S1702, the process proceeds to step S1705 to change it to “Move Mode.”

In this way, the fourth embodiment enables the operation mode (copy/cut/unselect, etc.) during a drag to be changed simply by a drag and stop operation.

### Fifth Embodiment

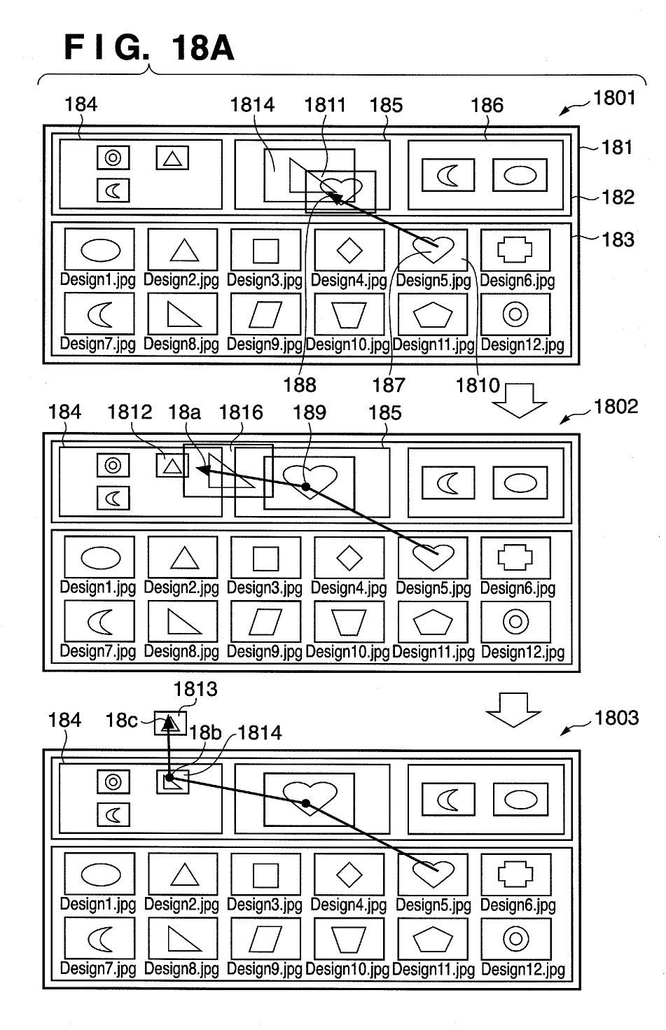

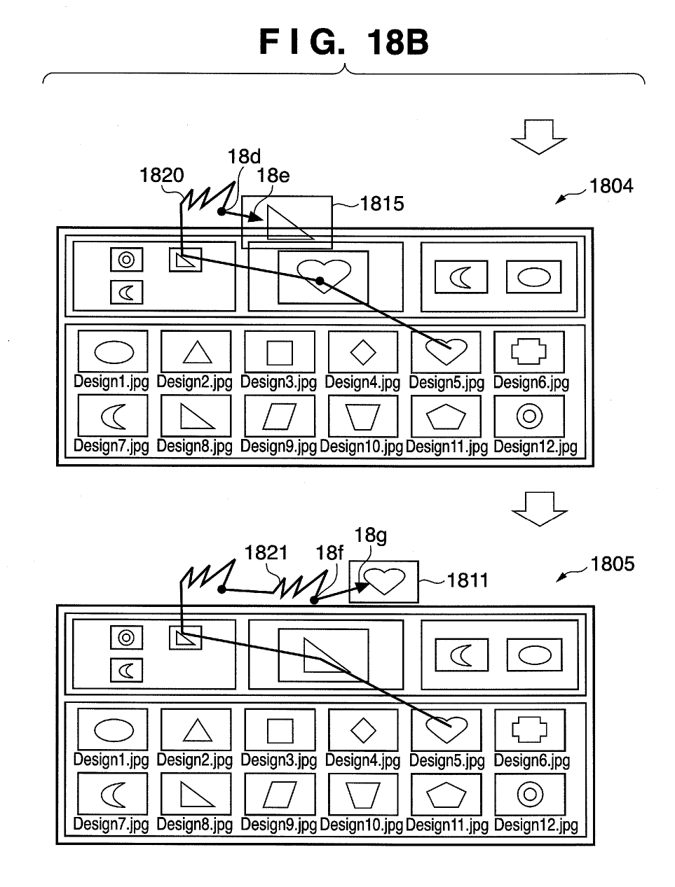

Next, a fifth embodiment of the present invention will be described with reference to FIGS. 18 to 21. In the fifth embodiment, an example is described where an immediately preceding drag stop operation can be canceled simply by a drag.

FIGS. 18A and 18B depict views illustrating an example of a state in which objects are dragged in the fifth embodiment of the present invention.

An object drag operation screen 181 has an other device display area 182 and an object display area 183 that displays a group of objects to be operated. In the other device display area 182, images 184, 185, and 186 corresponding to respective other devices are displayed.

In reference numeral 1801, an object 1810 in the object display area 183 corresponding to a drag start location 187 is dragged as 188 onto the image 185 corresponding to another apparatus. The drag object being dragged here is displayed as a transparent image 1811.

In reference numeral 1802, a drag stop at 189 is made on the image 185 by a continued drag, followed by a drag as 18a on the image 184 corresponding to another device. At this time, a new drag object 1814 is displayed as a transparent image 1816.

In reference numeral 1803, a drag stop at 18b is made on the image 184 by a further continued drag, followed by a drag as 18c out of the drag operation screen display area 181. Now, the drag object being dragged 1812 at this point is displayed as a transparent image 1813. Also, in reference numeral 1803, the object 1814 at the first drag stop location at 189 after the drag start is replaced with the object 1810 at the drag start location 187. Also shown is that the object 1812 at the second drag stop location 18b is replaced with the object 1814 at the first drag stop location 189, and the object 1812 at the second drag stop location 18b is deleted.

Next, in reference numeral 1804, a drag operation (e.g. successive up-and-down movements) 1820, which means the cancellation of the immediately preceding drag stop operation at 18b, is further performed by a continued drag. Next, a drag stop operation at 18d is made immediately after that, followed by a drag as 18e. Now, the immediately preceding movement of the object in reference numeral 1803 is canceled, and the drag object 1814 after the cancellation is displayed as a transparent image 1815.

Similarly, in reference numeral 1805, a drag operation 1821, which means the cancellation of processing by the second preceding drag stop operation at 189, is performed by a continued drag, followed by a drag stop operation at 18f and by a drag as 18g. Thereby now, the movement of the object 1810 at the stop at 189 is canceled, and the drag object 1810 after the cancellation is displayed as the transparent image 1811.

In this way, the execution result of the immediately preceding stop operation at 18b is undone by the first cancellation operation 1820, and further the execution result of the second preceding stop operation at 189 is undone by the next cancellation operation 1821. It should be noted that, if anther cancellation operation is performed in the state of reference numeral 1805, the drag from the drag start location 187, itself, will be canceled.

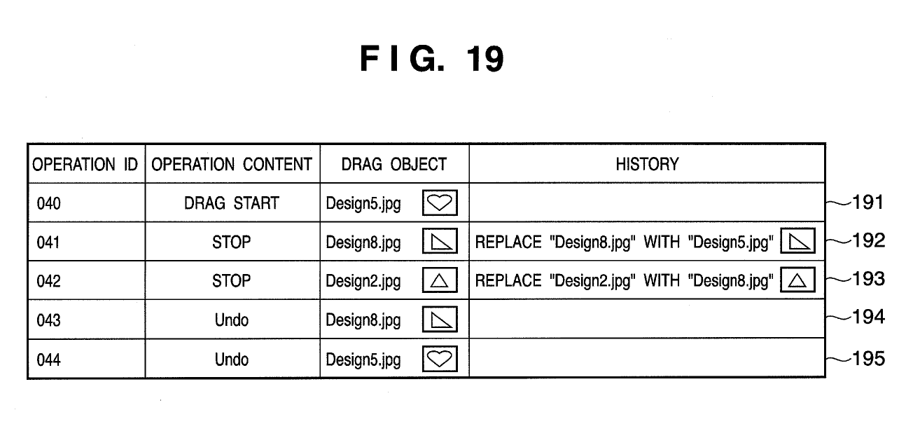

FIG. 19 depicts a view illustrating an example of drag object management data according to the fifth embodiment of the present invention, which is stored in the data memory 5.

The drag object management data stores operation IDs for uniquely identifying performed operations, the operation contents, the drag objects operated, and the change operation history. For example, drag object management data 191 stores “040” for the operation ID, “Drag Start” for the operation content, “Design5.jpg” for the drag object, and “None” for the operation history.

This corresponds to the state where the drag has been started from the drag start location 187, and the object 1810 “Design5.jpg” in the object display area corresponding to the start location 187 is being dragged 188 as a drag object as indicated by reference numeral 1801 in FIG. 18A.

Drag object management data 192 stores “041” for the operation ID, “Stop” for the operation content, “Design8.jpg” for the drag object, and “Replaced Design8.jpg with Design5.jpg” for the operation history.

This corresponds to the state where the drag stop at 189 has been made on the image 185 by the continued drag operation as indicated by reference numeral 1802 in FIG. 18A. Thus, it corresponds to the state where the object 1814 “Design8.jpg” of the image 185 has been replaced with the drag object 1810 “Design5.jpg.”

Drag object management data 194 stores “042” for the operation ID, “Stop” for the operation content, “Design2.jpg” for the drag object, and “Replaced Design2.jpg with Design8.jpg” for the operation history.

This corresponds to the state where the drag stop at 18b has been made on the image 184 by the continued drag as indicated by reference numeral 1803 in FIG. 18A. Thus, it corresponds to the state where the object 1812 “Design2.jpg” of the image 184 has been replaced with the drag object 1814 “Design8.jpg.”

Next, as an example corresponding to the cancellation operation 1820, drag object management data 194 stores “043” for the operation ID, “Undo” for the operation content, “Design8.jpg” for the drag object, and “None” for the operation history. That is, this stores the fact that the operation of the drag object management data 193 corresponding to the immediately preceding drag stop operation at 18b has been undone by the drag stop operation at 18d immediately after the cancellation operation 1820 performed in reference numeral 1804 in FIG. 18B.

Further, drag object management data 195 stores “044” for the operation ID, “Undo” for the operation content, “Design5.jpg” for the drag object, and “None” for the operation history. That is, this corresponds to the fact that the operation of the drag object management data 199 corresponding to the second preceding drag stop operation at 189 has been undone by the drag stop operation at 18f immediately after the cancellation operation 1821 performed in reference numeral 1805 in FIG. 18B.

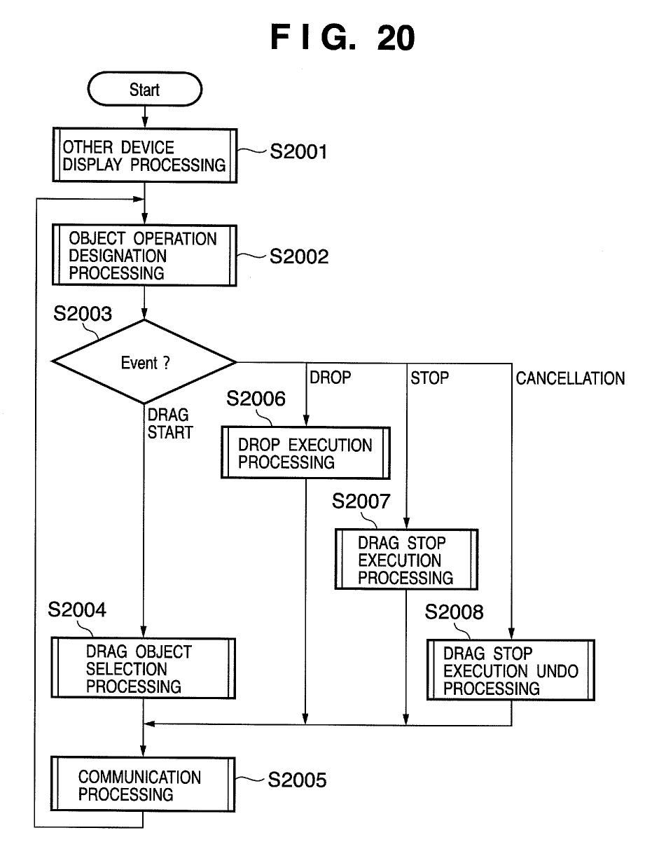

FIG. 20 is a flow chart illustrating the drag operation according to the fifth embodiment, which additionally includes cancellation processing S2008 in addition to the flow chart as shown in FIG. 5. The processing in steps S2001 to S2007 corresponds to the processing in steps S501 to S507 in FIG. 5.

In other device display processing in step S2001, the images of other devices are generated for display with reference to data for simulation obtained from the other devices, and then the following processing is repeated. Next, in object operation instruction processing in step S2002, an object operation designation by a user is received. Next, in step S2003, the process branches according to the operation designation. If the operation is determined to be a drag start in step S2003, the process proceeds to step S2004 to select the object at the drag start location using drag object selection processing and shifts into drag mode. Next, in communication processing in step S2005, the corresponding control data and object data is transmitted to the other device, and the process returns to step S2002 and repeats itself.

On the other hand, if the operation is determined to be a drop in step S2003, the process proceeds to step S2006 to execute on the drag object any processing of copy, move, delete, send, play, application launch, etc. corresponding to the drop location with a drop execution processing. Next the process releases the drag mode and proceeds to step 2005.

Also, if the operation is determined to be a drag stop in step S2003, the process executes processing corresponding to the stop during the drag on the drag object in drag stop execution processing in step S2007 and proceeds to step S2005.

Further, if the operation is determined to be a drag cancellation operation in step S2003, the process proceeds to step S2008 to undo the execution by the stop operation during the previous drag in the drag stop execution undo processing as described above, and proceeds to step S2005.

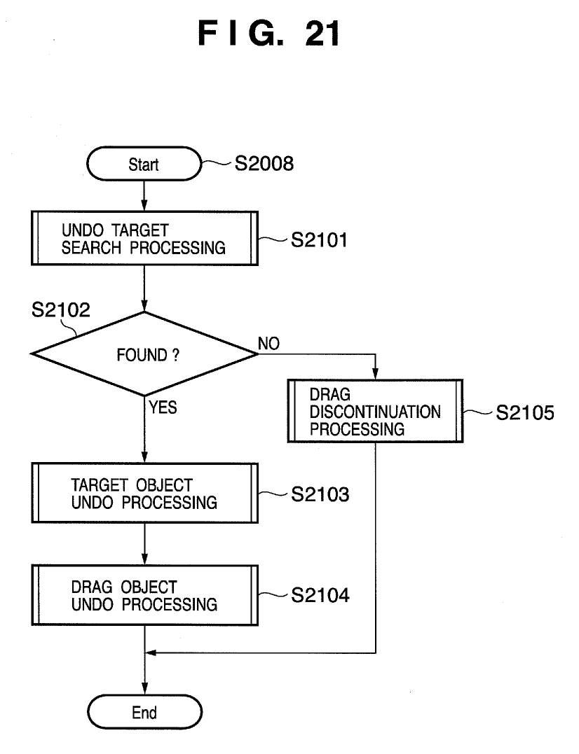

FIG. 21 is a flow chart illustrating the drag stop execution undo processing (S2008) according to the fifth embodiment of the present invention. This processing corresponds to the processing of the drag stop execution undo means 2b in FIG. 2.

First, in undo target search processing in step S2101, reference is made to the drag object management data shown in FIG. 19 to find an undo target. As a result, if it is determined that the undo target is found in step S2102, the process proceeds to step S2103 to undo the result of the performed operation with reference to the history using target object undo processing. Next, in drag object undo processing in step S2104, the process also undoes the object being dragged and ends.

On the other hand, if it is determined that no undo target is found in step S2102, the process proceeds to step S2105 to discontinue the drag itself using drag processing discontinuation processing and ends.

As described above, the fifth embodiment has an advantage that the execution result at the immediately preceding stop location can be canceled. This offers an advantage that the execution results of repeated stops can be canceled in sequence.

In the above-described embodiments, an object located in a drag stop position is replaced with an object (being dragged) located in a drag start position, and the object located in the drag stop position becomes a newly dragged object. The present invention is not limited to this. The dragged object may be copied to a plurality of drag stop positions without replacing an object located in a drag stop position with the dragged object.

It should be noted that the present invention also includes a case where a software program for implementing the functions of the above described embodiments is directly or remotely provided to a system or an apparatus, and the functions are achieved by causing the computer of the system or the apparatus to read out and execute the provided program code. In that case, the implementation does not necessarily need to be in the form of a program if the functions of the program are provided. Accordingly, it is intended that the program code itself, which is installed in a computer to achieve the functional processing of the present invention using the computer, also accomplishes the present invention. That is, the present invention includes the computer program itself for achieving the functional processing of the present invention. In that case, the program may be provided in any form, such as an object code, a program executed by an interpreter, script data provided to an OS, etc. if only the functions of the program are provided.

The storage media for providing the program may include, for example, floppy (registered trademark) disks, hard disks, optical disks, magneto-optical disks, MO, CD-ROM, CD-R, CD-RW, magnetic tapes, non-volatile memory cards, ROM, DVD (DVD-ROM, DVD-R), etc. Another method for providing the program is to connect to a Web site on the Internet using a browser on a client computer and to download the computer program of the present invention itself or its compressed file with an auto-install function from the Web site to a storage medium such as a hard disk. It may also be achieved by dividing the program code constituting the program of the present invention into a plurality of files, and allowing the respective files to be downloaded from different Web sites. That is, a WWW server that allows a plurality of users to download the program files for implementing the functional processing of the present invention on a computer is also intended to be included in the claims of the present invention.

The functions of the above described embodiments may also be implemented by distributing among users the program of the present invention which is encrypted and stored on a storage medium such as CD-ROM, and allowing users who satisfy a predetermined condition to download the decryption key information from a Web site over the Internet, and to execute and install the encrypted program in the computer by using the key information.

The functions of the above described embodiments may be achieved not only by a computer reading out and executing the program, but also by an OS or the like running on the computer performing part or all of the actual processing based on the instructions of the program.

Further, the functions of the above described embodiments may also be achieved by, after writing the program read out from the recording medium in a memory provided in an expansion board inserted into a computer or an expansion unit connected to a computer, causing the CPU or the like provided in the expansion board or the expansion unit to execute part or all of the actual processing based on the instructions of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-246428, filed Aug. 26, 2005, which is hereby incorporated by reference herein in its entirety.

What is claimed is:

1. An information processing apparatus, comprising:
drag means for, in response to a drag of a first object on a screen, shifting to a drag state in which the first object is moved across the screen,
determination means for determining whether the movement of the first object has stopped for a predetermined time period during the drag, and
object execution means for executing processing of the first object, in a case that said determination means determines that the movement of the first object has stopped for the predetermined time period.

2. The information processing apparatus according to claim 1, wherein said object execution means executes any processing of deleting the first object, moving or copying the first object to the stopped location, or activating processing corresponding to an icon at the stopped location.

3. The information processing apparatus according to claim 2, wherein said object execution means further replaces the first object with a second object lying on the stopped location.

4. The information processing apparatus according to claim 3, wherein said determination means and said object execution means are also applicable to the second object.

5. The information processing apparatus according to claim 3, further comprising drag clarification means for identifiably displaying the drag of the second object.

6. The information processing apparatus according to claim 1, further comprising:
drag object determination means for determining whether the object at the location where said determination means determines that the movement of the object has stopped for the predetermined time period is the object that has been selected by the drag, and
drag object addition means for, in a case that said drag object determination means determines that the object is the selected object, adding an object at a location through which a cursor moved by the drag from the drag start location or a previous stop location has passed as an object for the drag.

7. The information processing apparatus according to claim 6, further comprising drag mode change means for changing the processing of the object executed by said object execution means, in a case that said drag object determination means determines that the object is the selected object and there is no additional object to be added by said drag object addition means.

8. The information processing apparatus according to claim 1, further comprising:
detection means for detecting a predetermined drag operation during the drag, and
cancellation means for canceling an execution result by said object execution means immediately before the predetermined drag operation in response to the predetermined drag operation detected by said detection means.

9. The information processing apparatus according to claim 8, wherein said cancellation means can be executed several times in series.

10. The information processing apparatus according to claim 1, further comprising re-drag means for again shifting to a drag state of the first object from a location where the movement of the first object has stopped for the predetermined time period, in response to a drag after the determination by said determination means.

11. A processing method of dragging a drag object on an information processing apparatus having at least a display unit and an input unit for specifying coordinates on a screen of the display unit, comprising:
a drag step of, in response to a drag of a first object selected on the screen, shifting to a drag state in which the first object is moved across the screen,
a determination step of determining whether the movement of the first object has stopped for a predetermined time period during the drag, and
an object execution step of executing processing of the first object, in a case that it is determined in said determination step that the movement of the first object has stopped for the predetermined time period.

12. The method according to claim 11, wherein said object execution step executes any processing of deleting the first object, moving or copying the first object to the stopped location, or activating processing corresponding to an icon at the stopped location.

13. The method according to claim 11, wherein said object execution step further replaces the first object with a second object lying on the stopped location.

14. The method according to claim 13, wherein said determination step and said object execution step are also applicable to the second object.

15. The method according to claim 13, further comprising a drag clarification step of identifiably displaying the drag operation of the second object.

16. The method according to claim 11, further comprising:
a drag object determination step of determining whether the object at the location where it is determined in said determination step that the movement of the object has stopped for the predetermined time period, is the object that has been selected by the drag operation, and
a drag object addition step of, in a case that it is determined in said drag object determination step that the object is the selected object, adding an object at a location through which a cursor moved by the drag operation from the drag start location or a previous stop location has passed as an object for the drag operation.

17. The method according to claim 16, further comprising a drag mode change step of changing the processing of the object executed in said object execution step, in a case that it is discriminated in said drag object determination step that the object is the selected object and there is no additional object to be added in said drag object addition step.

18. The method according to claim 11, further comprising:
a detection step of detecting a predetermined drag operation during the drag, and
a cancellation step of canceling an execution result in said object execution step immediately before the predetermined drag operation in response to the detection of the predetermined drag operation in said detection step.

19. The method according to claim 18, wherein said cancellation step can be executed several times in series.

20. The method according to claim 11, further comprising a re-drag step of again shifting to a drag state of the first object from a location where the movement of the first object has stopped for the predetermined time period, in response to a drag after the determination in said determination step.
